(19) United States
(12) Patent Application Publication
(10) Pub. No.: US 2005/0179664 A1
(43) Pub. Date: Aug. 18, 2005

(54) Keyboard with extension keys and method for setting key codes of the extension keys thereof

(76) Inventor: Yuan-Chen Lee, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/777,169

(22) Filed: Feb. 13, 2004

(51) Int. Cl. G09G 5/00

(52) U.S. Cl. 345/168

(57) ABSTRACT

A keyboard with extension keys and method for setting key codes of the extension keys thereof is described. The main body of the keyboard has a setting key and extension keys disposed thereon, and has a keyboard controller and a memory disposed therein. The keyboard controller is used to control the main body and the memory is used to store the key codes of the extension keys. The setting key is used to actuate a setting routine to set the key codes of the extension keys and then, a user can choose one of the extension keys and input a setting string by pressing standard keys. The setting string is stored in the memory as the key code of the chosen extension key. Thereby, the user can define the key codes of the extension keys so that the extension keys can be full of variety.

### FIELD OF THE INVENTION

The present invention is directed to a keyboard with extension keys and method for setting key codes of the extension keys thereof, and more particularly, to a keyboard that a user can define key codes of keys thereof.

### BACKGROUND OF THE INVENTION

In accordance with prior art, a keyboard is an important input device for a computer. It has keys with various functions and a user only needs to press the keys to input a command to control the computer. When one of the keys is pressed, the keyboard will output a key code to the computer. Then, the computer will identify the key code and execute a corresponding function.

Generally, a standard keyboard used for a computer employs a coding standard complying with the American standard code for information interchange (ASCII) and ISO646. It uses seven bits to provide 128 standard codes, of which 94 codes are graphic character codes and 34 codes are control character codes. However, after assigning the usually used graphic character codes and control character codes, not many codes are left.

Therefore, International Business Machines (IBM) Company has defined extended codes to solve this problem. It uses an additional extension key with “E0” code, which can be combined with the standard codes to form the extended codes. The extended codes can be used for various extended functions, such as music playing, pausing, song selection, volume adjusting, home page opening and calculator actuating.

The computer can already identify the standard codes output from the standard keyboard, but it still needs a hook program to identify the extended codes. If the “E0” code exists in a code output from the keyboard, the code is an extended code and the computer will execute a corresponding application program.

Therefore, in the aspect of keyboard, the keys of the standard keyboard and the additional extension key described above each can only generate a fixed and unchangeable key code. Hence, if a user wants to modify the function of the extension key, he can only modify the application program of the computer to reach it. This method can only be applied to a computer with the application program used for the extension key.

Summing up, for a keyboard with an extension key, a user cannot directly modify the key code of the extension key to define the function of the extension key himself.

### SUMMARY OF THE INVENTION

An objective of the present invention is to provide a keyboard with extension keys and method for setting key codes of the extension keys thereof. A use can define the functions of the extension keys and the set values can be stored in the keyboard so that the keyboard adapts to use with any computer.

Accordingly, the present invention provides a keyboard with extension keys, including a main body having at least an extension key; a keyboard controller for controlling the main body; and a memory connecting with the main body for storing a key code of the extension key.

The present invention also provides a method for setting key codes, which is used for a keyboard having at least an extension key. The method comprises executing an application program of a computer, choosing the extension key, inputting a setting string, storing the setting string into the keyboard and setting the setting string to be a key code of the extension key.

The present invention provides another method for setting key codes, which is used for a keyboard having at least an extension key. The method comprises pressing a setting key of the keyboard, choosing the extension key, inputting a setting string, storing the setting string into the keyboard and setting the setting string to be a key code of the extension key.

Numerous additional features, benefits and details of the present invention are described in the detailed description, which follows.

### BRIEF DESCRIPTION OF THE DRAWINGS

FIG. 1 shows a schematic diagram of a preferred embodiment according to the present invention;

FIG. 2 shows a circuit block diagram of the preferred embodiment according to the present invention, respectively;

FIG. 3 is a method flowchart of the preferred embodiment according to the present invention;

FIG. 4 is a schematic diagram of a screen frame for showing key codes of extension keys; and

FIG. 5 is a schematic diagram of a screen frame for setting the extension keys.

### DETAILED DESCRIPTION

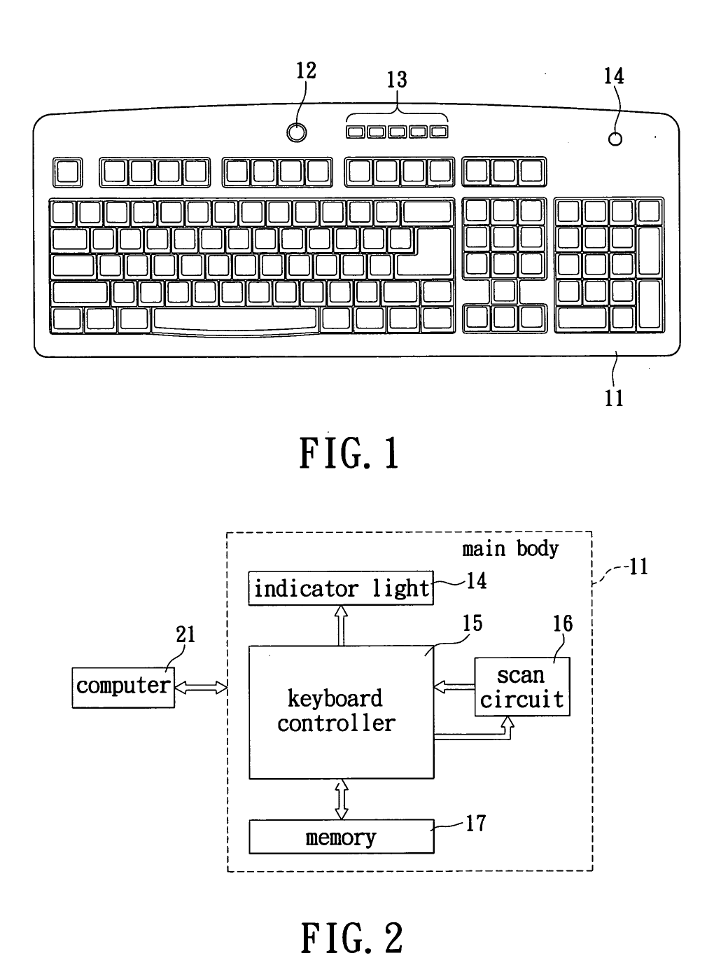

Reference is made to FIGS. 1 and 2, which show a schematic diagram and circuit block diagram of a preferred embodiment according to the present invention, respectively. The present invention relates to a keyboard with extension keys. The main body 11 of the keyboard not only has standard keys but also has a setting key 12, extension keys 13 and an indicator light 14. The setting key 12 is used to actuate a setting routine to set the key code of the extension keys 13. Hence, a user can define the key codes output from the extension keys 13 himself. The indicator light 14 is used to indicate the execution state of the setting routine. Illumination of indicator light 14 indicates that the main body 11 is setting the key codes of the extension keys 13. When indicator light 14 is dark, the main body 11 is controlling the general keys.

The internal circuit of the main body 11 has a keyboard controller 15, a scan circuit 16 and a memory 17. The keyboard controller 15 is used to control the operation of the main body 11, the scan circuit 16 is connected with the keyboard controller 15 to detect the scan codes generated by the keys, and the memory 17 is connected with the keyboard controller 15 to store the key codes of the extension keys 13. The memory 17 can be electrically erasable programmable read-only memory (EEPROM) or flash memory.

The keyboard controller 15 has a firmware of the setting routine disposed therein to execute the setting of the key codes of the extension keys. When the setting key 12 is pressed, the setting routine will set key codes of the extension keys 13 and store the key codes into the memory 17. Hence, after executing the setting routine completely, the extension keys 13 will output the key codes according to the data stored in the memory 17 when the extension keys 13 are pressed.

Therefore, when the main bode 11 of the keyboard is connected with the computer 21, the key codes of the extension keys 13 can be set by the setting routine of the main body 11. On the other hand, the key codes of the extension keys 13 also can be set and stored into the memory 17 of the main body 11 by an application program of the computer 21.

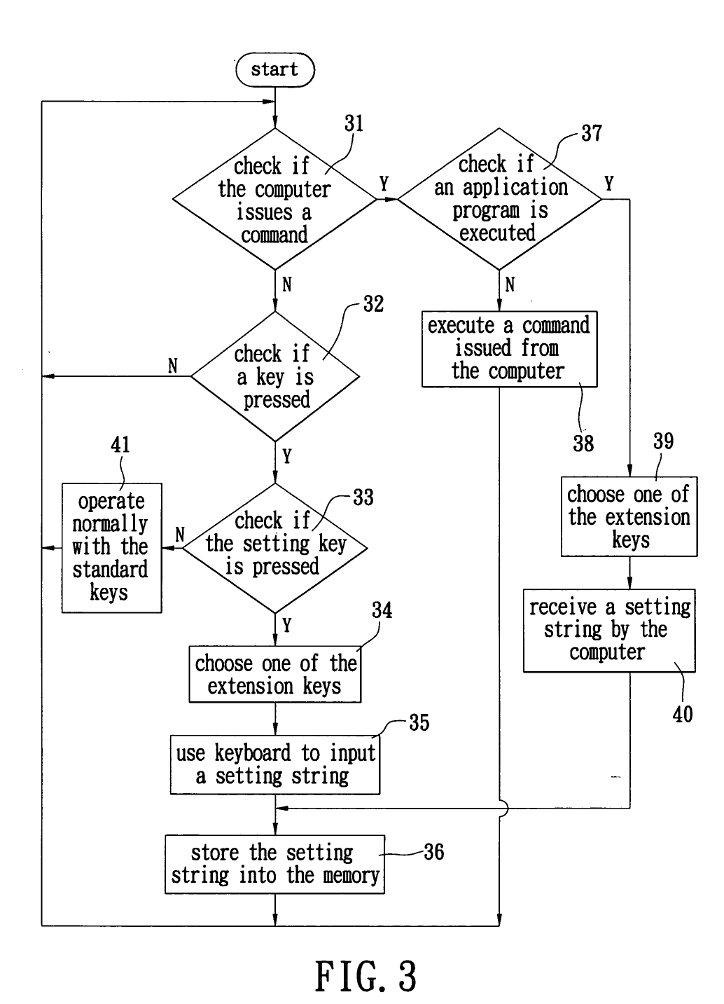

Reference is made to FIG. 3, which is a method flowchart of a preferred embodiment according to the present invention. It includes the following steps:

Step 31: check if the computer 21 issues a command. If positive, jump to step 37; otherwise, jump to step 32.

Step 32: check if a key is pressed. If positive, jump to step 33; otherwise, jump back to step 31.

Step 33: check if the setting key 12 is pressed. If positive, jump to step 34; otherwise, jump to step 41.

Step 34: choose one of the extension keys 13, meaning that one of the extension keys 13 of the main body 11 should be pressed.

Step 35: use the keyboard to input a setting string. If a key of the keyboard is pressed, an alphabetic string is input. Likewise, if several keys of the keyboard are pressed, several alphabetic strings are input. The number of the alphabetic strings input to form the setting string is unlimited. Then, press the setting key 12 to finish inputting the setting string. The alphabetic strings refer to the scan codes of the keys. Each scan code includes a make code and a break code for indicating pressing and releasing of the corresponding key.

Step 36: store the setting string into the memory 17 of the keyboard and jump back to step 31.

Step 37: check if an application program is executed. If positive, jump to step 39; otherwise, jump to step 38.

Step 38: execute a command issued from the computer and jump back to step 31.

Step 39: choose one of the extension keys 13 by inputting its code name or directly pressing it. The code name is determined by the setting routine of the keyboard controller 15.

Step 40: receive a setting string by the computer 21. If a key is pressed, an alphabetic string is input. Likewise, if several keys are pressed, several alphabetic strings are input. The alphabetic strings refer to the scan codes of the keys. Each scan code includes a make code and a break code for indicating pressing and releasing of the corresponding key. Then, jump to step 36.

Step 41: operate normally with the standard keys. Then, go back to step 31.

In step 36, the setting string stored in the memory 17 is set as the key code of the chosen one of the extension keys 13. There are two ways to set the key codes of the extension keys 13. One is to press the setting key 12 as shown in step 33. The other is to execute the application program of the computer 21 as shown in step 37.

As described above, the method for setting key codes of the extension keys according to the present invention is first to actuate a setting routine, which can be actuated by the setting key 12 or the application program. Then, a user can choose one of the extension keys 13 and input its key code. The key code can be input by directly pressing the keys of the keyboard to obtain the corresponding scan codes, storing the scan codes into the memory 17 and then setting those scan codes as the key code of the chosen extension key 13.

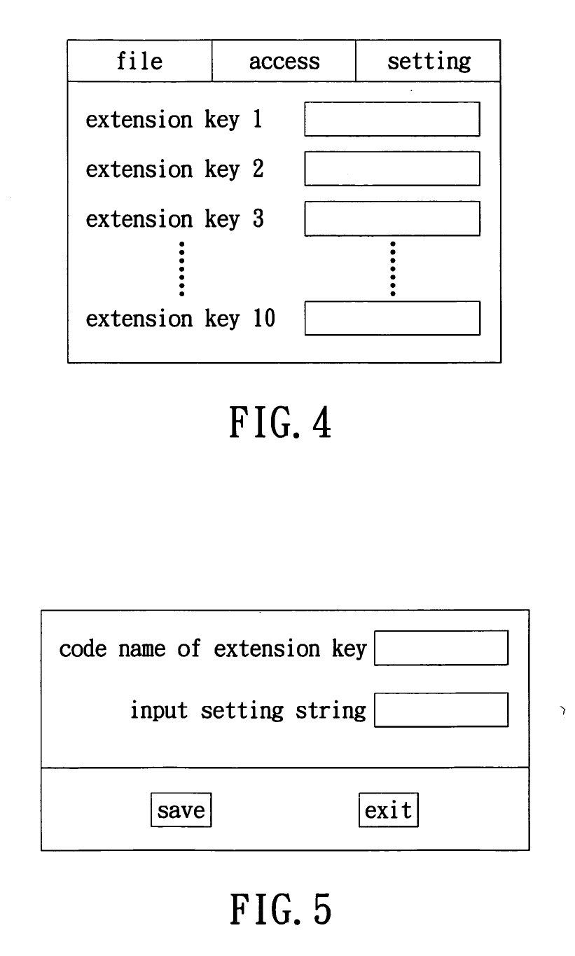

Reference is made to FIGS. 4 and 5, which are the schematic diagrams of the screen frame for showing the key codes of the extension keys and the screen frame for setting the extension keys. When the application program is actuated for setting the extension keys 13, the computer 21 will generate a screen frame as illustrated in FIG. 4, which shows the key codes of the extension keys. The screen frame also has a menu for opening files, accessing the memory of the keyboard and setting the key codes. When the setting item is chosen, the computer 21 will generate a screen frame as illustrated in FIG. 5 for setting the key codes of the extension keys.

An example of using the present invention is as following. A user usually uses a keyboard while playing current video games. If playing a fistfight game, due to its fast cadence, the user will press the keys very often and usually will press several keys in a short period. Hence, by applying the present invention, the user can set the keys of the extension keys so that one extension key can function as several keys. For instance, if the user needs the press A, B and C keys sequentially, he can actuate the setting routine of the extension keys 13 and store the scan codes of A, B, C keys into the memory 17 as a key code of a chosen extension keys. Hence, the user can press the chosen extension key to generate the scan codes of A, B, C keys and the keyboard controller 15 will identify the chosen extension key as the A, B, C keys.

Accordingly, the keyboard with extension keys and method for setting key codes of the extension keys thereof according to the present invention has following features:

(1) Functions of several keys can be replaced by the function of one extension key.

(2) After the key codes of the extension keys are set completely, the key codes are stored in the internal memory of the keyboard. Hence, the keyboard with the extension keys according to the present invention is adaptable to use with any kinds of computers. When one of the extend keys is pressed, it will generate a corresponding key code to perform a corresponding function without changing the setting of the computers.

(3) The key codes of the extension keys can be modified according to user's requirements.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A keyboard with extension keys, comprising:
a main body having at least an extension key;
a keyboard controller for controlling the main body; and
a memory connecting with the main body for storing a key code of the extension key.

2. The keyboard as claimed in claim 1, wherein the main body further has a setting key, which cooperates with a firmware of the keyboard controller to set the key code of the extension key.

3. The keyboard as claimed in claim 2, wherein the main body further has an indicator light, which indicates an operating state of the setting key.

4. The keyboard as claimed in claim 1, wherein the memory is an electrically erasable programmable read-only memory (EEPROM) or flash memory.

5. A method for setting key codes, used for a keyboard having at least an extension key, the method comprising:
executing an application program of a computer;
choosing the extension key;
inputting a setting string; and
storing the setting string into the keyboard and set the setting string to be a key code of the extension key.

6. The method as claimed in claim 5, wherein the keyboard has a memory for storing the setting string.

7. The method as claimed in claim 5, wherein the step of choosing the extension key is reached by inputting a code name of the extension key or directly pressing the extension key.

8. The method as claimed in claim 5, wherein the setting string is a scan code of the extension key.

9. The method as claimed in claim 8, wherein the scan code comprises a make code and a break code for indicating pressing and releasing of the extension key.

10. A method for setting key codes, which is used for a keyboard having at least an extension key, the method comprising:
pressing a setting key of the keyboard;
choosing the extension key;
inputting a setting string; and
storing the setting string into the keyboard and set the setting string to be a key code of the extension key.

11. The method as claimed in claim 10, wherein the keyboard has a memory for storing the setting string.

12. The method as claimed in claim 10, wherein the step of choosing the extension key refers to pressing the extension key.

13. The method as claimed in claim 10, wherein the setting string is a scan code of the extension key.

14. The method as claimed in claim 13, wherein the scan code comprises a make code and a break code for indicating pressing and releasing of the extension key.

15. The method as claimed in claim 10 further comprising:
pressing the setting key to finish inputting the setting string.
